(19) United States
(12) Patent Application Publication
(10) Pub. No.: US 2004/0010750 A1
(43) Pub. Date: Jan. 15, 2004

(54) Information storage medium, method of reproducing data from the information storage medium, and apparatus for reproducing data from the information storage medium, supporting interactive mode

(75) Inventors: Hyun-Kwon Chung, Seoul (KR); Jung-wan Ko, Gyeonggi-do (KR); Jung-kwon Heo, Seoul (KR); Sung-wook Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/445,197

(22) Filed: May 27, 2003

(30) Foreign Application Priority Data
May 24, 2002 (KR) 2002-28923

(51) Int. Cl. G06F 7/00; G06F 12/00

(52) U.S. Cl. 715/501.1; 707/3; 707/200; 711/118

(57) ABSTRACT

A method of and an apparatus for reproducing data from the information storage medium, which supports an interactive mode, includes caching at least part of search information necessary to access mark-up language documents in a memory, and reading the mark-up language documents by referring to the cached search information.

### CROSS-REFERENCE TO RELATED APPLICATION

This application claims the benefit of Korean Patent Application No. 2002-28923, filed on May 24, 2002 in the Korean Intellectual Property Office, the disclosure of which is incorporated herein in its entirety by reference.

### BACKGROUND OF THE INVENTION

1. Field of the Invention

The present invention relates to an information storage medium, a method of reproducing data from the information storage medium, and an apparatus to reproduce data from the information storage medium, which can display audio-video (AV) data recorded on the information storage medium in an interactive mode.

2. Description of the Related Art

Interactive digital versatile discs (DVDs) are DVDs from which data can be reproduced in an interactive mode by loading the DVD in a DVD drive installed in a personal computer (PC). Interactive DVDs are being sold in the market place. Specifically, the interactive DVD is a DVD on which AV data are recorded along with a mark-up language document. The AV data recorded on an interactive DVD can be reproduced in two different modes. One mode is a video mode, which is the same as the way AV data recorded on a typical DVD are displayed. The other mode is an interactive mode in which an AV screen obtained by reproducing the AV data is displayed through a display window defined by one or more mark-up language documents.

A mark-up language document viewer is, for example, a browser, and which interprets and displays the HTML documents. The viewer is capable of allowing a user to view the mark-up language documents loaded in a PC when the user selects an interactive mode. The viewer further interprets and displays the mark-up language documents recorded on the interactive DVD. In a display window described by the interpreted mark-up language documents, the AV data selected by the user are displayed.

HTML documents are representative examples of mark-up language documents. Using the HTML documents, when the AV data to be displayed is a movie, for example, the moving images of the movie are displayed in the display window defined by an HTML document. In addition, various additional information, such as the film script, synopsis, and actors and actresses' photos, are displayed in other regions of the HTML document.

A conventional DVD uses a universal disk format (UDF) bridge as a file system. The term “UDF bridge” means that both UDF subsets and ISO9660 are used together. In an interactive mode, a plurality of mark-up language documents as well as the AV data is necessary. According to an AV data structure defined by DVD-Video standards, it is not difficult to the read AV data because there is no need to again analyze the volume structure and file structure of a file system once an information file VIDEO_TS.IFO is found. The VIDEO_TS.IFO file controls reproduction of AV data and is found by analyzing information on the volume structure and file structure of the file system. It is possible to read desired the AV data using information recorded in the AV data reproduction control information file VIDEO_TS.IFO. However, it is necessary to perform a process of analyzing the volume structure and file structure of the file system whenever there is a need to read a mark-up language document.

For example, it is assumed that an optical pickup is required to move six times to analyze the volume structure and file structure of a file system whenever a file recorded on an interactive DVD is accessed, and that it takes 100 msec to move the optical pickup only once. Therefore, the optical pickup must move a total of 12 times in order to read a mark-up language document and an image file to be displayed with the mark-up language, which thus requires taking 1,200 msec to read the mark-up language document and the image file. If there are five image files to be displayed with a mark-up language, 3,000 msec (6×5×100=3000) will be taken to read the mark-up language and the five image files.

### SUMMARY OF THE INVENTION

Aspects of the present invention provide an information storage medium, on which data are recorded to have a structure making it possible to effectively read mark-up language documents and/or their linked files, a method of recording data on the information data storage medium, an apparatus to record data on the information data storage medium, a method of reproducing data from the information data storage medium, and an apparatus to reproduce data from the information data storage medium.

Additional aspects and advantages of the invention will be set forth in part in the description which follows and, in part, will be obvious from the description, or may be learned by practice of the invention.

According to an aspect of the present invention, an information storage medium includes mark-up language documents for use in reproducing AV data in an interactive mode, and search information necessary to access the mark-up language document, where at least part of the search information is designated to be cached in a memory and is used to access at least some of the mark-up language documents.

According to another aspect of the present invention, the information storage medium further includes the AV data, and the search information is information used to access the AV data.

According to yet another aspect of the present invention, the search information is information used to access mark-up language documents stored in an additional directory among the mark-up language documents.

According to still another aspect of the present invention, the search information is recorded using a file system, the volume structure and file structure of which can be analyzed.

According to yet sill another aspect of the present invention, the file system is one of a UDF file system and an ISO9660 file system.

According to a further aspect of the present invention, an information storage medium includes a video directory, which stores AV data including audio data and/or video data, and an interactive directory, which stores mark-up language documents for reproducing the AV data in an interactive mode, where the interactive directory includes a cache directory as a sub-directory and the data structure of the cache directory is cached in a memory.

According to a still further aspect of the present invention, the data structure is search information necessary to access the mark-up language documents belonging to the cache directory.

According to an additional aspect of the present invention, an information storage medium includes an interactive directory including at least one sub-directory where mark-up language documents for reproducing AV data in an interactive mode are stored. Reproduction control information on the mark-up language documents is recorded in the interactive directory, and a reproduction control information file including cache directory designation information for designating a cache directory that is stored in the interactive directory, and a data structure of the cache directory is to be cached in a memory.

According to a still additional aspect of the present invention, the data structure includes search information necessary to access the mark-up language documents belonging to the cache directory and is cached in the memory.

According to a yet additional aspect of the present invention, the data structure is recorded using a file system, the volume structure and file structure of which can be analyzed.

According to yet still additional aspect of the present invention, the file system adopts at least one of a UDF file system and an ISO9660 file system.

According to another aspect of the present invention, a method of reproducing AV data in an interactive mode includes caching at least part of search information necessary to access mark-up language documents in a memory, and reading the mark-up language documents by referring to the cached search information.

According to yet another aspect of the present invention, the method further includes reproducing the AV data in an interactive mode using the read mark-up language documents.

According to still another aspect of the present invention, the caching includes analyzing a file system recorded on an information storage medium where the mark-up language documents are recorded, and caching the volume structure and file structure of part of the analyzed file system necessary to access at least some of the mark-up language documents in a memory.

According to another aspect of the present invention, a method of reproducing AV data in an interactive mode includes analyzing lead-in information, analyzing a file system, caching in a memory at least part of a file system necessary to access mark-up language documents, reading the mark-up language documents by referring to the cached file system, and displaying the AV data in an interactive mode using the read mark-up language documents.

According to yet another aspect of the present invention, the caching includes caching a file system used to access a cache directory, which is a sub-directory of an interactive directory which stores the mark-up language documents in the memory.

According to still another aspect of the present invention, the caching further includes determining the cache directory, which is a sub-directory of the interactive directory in which the mark-up language documents are stored, by analyzing a reproduction control information file where reproduction control information on the interactive directory is recorded, and caching a file system for accessing the cache directory in a memory.

According to yet still another aspect of the present invention, the displaying the AV data includes searching for a video directory where the AV data are stored and caching a reproduction control information file for the AV data in a memory, and reading the AV data by referring to the cached reproduction control information file.

According to an additional aspect of the present invention, the file system adopts at least one of a UDF file system and an ISO9660 file system.

According to another aspect of the present invention, a method of reproducing data, in an interactive mode, from a DVD where mark-up language documents are recorded based upon an ISO9660 file system includes interpreting a volume area, interpreting a main volume descriptor sequence by referring to an anchor point, interpreting a file set descriptor, interpreting a file entry of a root directory, interpreting a root directory record, interpreting a file entry of an interactive directory, interpreting a interactive directory record, searching for a file entry of a start document by reading a file identification descriptor, caching a path table regarding at least some of the mark-up language documents, caching a directory record corresponding to the path table, and reproducing the AV data in an interactive mode with the corresponding mark-up language documents with reference to the cached path table and the directory record.

According to yet another aspect of the present invention, the method further includes interpreting a file entry of a video directory, interpreting a video directory record, and caching necessary reproduction control information by interpreting a reproduction control information file stored in the video directory.

According to a further aspect, the reproducing the AV data in the interactive mode includes reading the AV data by referring to the reproduction control information.

According to another aspect of the present invention, an apparatus for reproducing data, in an interactive mode, from an information storage medium on which are recorded mark-up language documents for reproducing AV data stored on the information storage medium in an interactive mode includes a reader which reads data recorded on the information storage medium, a cache memory which caches search information read by the reader, a controller which commands at least part of search information necessary to access the mark-up language documents to be read and mark-up language documents corresponding to the search information cached in the cache memory, a presentation engine which interprets mark-up language documents read by the reader, a buffer memory which decodes AV data buffered by the buffer memory, and a blender which blends the AV data decoded by the decoder and the mark-up language documents interpreted by the presentation engine and outputs the blended result.

According to still another aspect of the present invention, the controller analyzes a file system recorded on the information storage medium, commands the reader to read part of the file system necessary to access at least some of the mark-up language documents, and controls the cache memory so that the read file system can be cached in the cache memory.

### BRIEF DESCRIPTION OF THE DRAWINGS

The above and/or other features and advantages of the present invention will become more apparent and more readily appreciated by describing in detail exemplary embodiments thereof with reference to the accompanying drawings in which:

FIG. 1 is a diagram illustrating a data reproduction system according to an embodiment of the present invention;

FIG. 2 is a block diagram of an apparatus for reproducing data from an information storage medium according to an embodiment of the present invention;

FIG. 3 is a diagram illustrating the structure of a DVD according to an embodiment of the invention;

FIGS. 4 and 5 are diagrams illustrating an example of an ISO9660 file system for use with the DVD of FIG. 3;

FIG. 6 is a diagram illustrating an example directory structure of the DVD of FIG. 3;

FIG. 7 is a diagram illustrating an ISO9660 file system according to the directory structure shown in FIG. 6;

FIG. 8 is a diagram illustrating another example of the directory structure of the DVD of FIG. 3;

FIG. 9 is a diagram illustrating an ISO9660 file system according to the directory structure shown in FIG. 8;

FIG. 10 is a diagram illustrating another example of the directory structure of the DVD of FIG. 3;

FIG. 11 is a diagram illustrating an ISO9660 file system according to the directory structure shown in FIG. 10;

FIG. 12 is a flowchart of a method of reproducing data from an information storage medium according to an embodiment of the present invention;

FIG. 13 is a flowchart of a method of reproducing data from an information storage medium according to another embodiment of the present invention;

FIG. 14 is a flowchart of a method of reproducing data from an information storage medium according to still another embodiment of the present invention;

FIG. 15 is a diagram illustrating an example of operation 1411 shown in FIG. 14;

FIG. 16 is a diagram illustrating another example of operation 1411 shown in FIG. 14; and

FIG. 17 is a flowchart of a method of reproducing data from an information data storage according to yet still another embodiment of the present invention.

### DETAILED DESCRIPTION OF THE EMBODIMENTS

Hereinafter, the present invention will now be described in greater detail with reference to the accompanying drawings, in which embodiments of the invention are shown. Like reference numerals refer to the like elements throughout. The embodiments are described below in order to explain the present invention by referring to the figures.

In the following paragraphs, the term “mark-up language document” will be used to refer to a document written in a mark-up language, such as HTML or XML, or a document written in a Script language or Java with a source code linked thereto or inserted thereinto. In addition, the term “mark-up language document” also includes a mark-up language document with files linked thereto. In other words, the mark-up language document serves as sort of an application for reproducing AV data in an interactive mode and contains additional information to be displayed with the AV data.

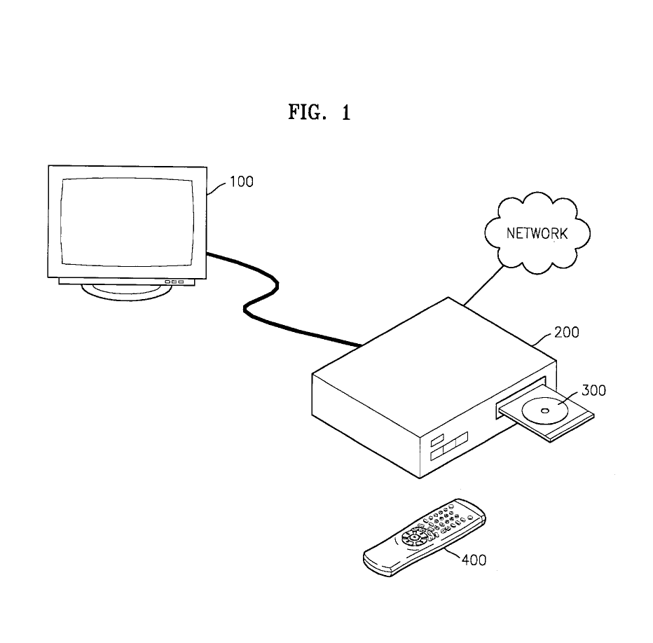

FIG. 1 is a diagram illustrating a data reproduction system according to an embodiment of the present invention. Referring to FIG. 1, the reproduction system includes a DVD 300, which is an information storage medium according to an embodiment of the present invention, an apparatus 200 for reproducing data with respect to the DVD 300, a television (TV) 100, which is a display device according to an embodiment of the present invention, and a remote controller 400. The remote controller 400 receives a control command from a user and transmits the control command to the apparatus 200 so as to the data from the DVD 300.

The apparatus 200 includes a DVD drive for reproducing data recorded on the DVD 300. When the DVD 300 is loaded in the DVD drive and the user selects an interactive mode, the apparatus 200 reproduces audio/video (AV) data in an interactive mode using mark-up language documents stored on the DVD 300. The apparatus 200 transmits the reproduced AV data to the TV 100. An AV screen obtained from the AV data is displayed on the TV 100 along with a mark-up language document screen obtained from mark-up language documents.

The interactive mode indicates a manner of reproducing the AV data so that the AV screen can be displayed in a display window such that the AV screen can be embedded in the mark-up language document screen. Here, the AV screen indicates a screen that is obtained by reproducing AV data and displayed on a display device, and the mark-up language document screen indicates a screen that is obtained by interpreting mark-up language documents and then displayed on a display device. A video mode indicates a method of reproducing data from a conventional DVD-Video (i.e., a method of displaying an AV screen obtained by reproducing AV data).

In the present embodiment, the apparatus 200 for reproducing data supports both the interactive mode and the video mode. In addition, the apparatus 200 for reproducing data can be connected to a network, such as the Internet, so that the apparatus 200 can receive and transmit data over the network. As such, the apparatus 200 can use the interactive mode to communicate over the network, such as for use in purchasing items.

While described in terms of a TV 100, it is understood that other types of display devices, such as plasma display panels, flat panel displays, liquid crystal displays, LED and OLED, can be used. Further, other types of recording media can be used in place of the DVD 300, such as a CD, CD-R, CD-RW, DVD-R, DVD-RW, and Blu-ray and AOD discs. Additionally, it is understood that the apparatus 200 can include a recording apparatus so as to record the video data and the markup language documents on the DVD 300 so as to be reproducible in the interactive mode.

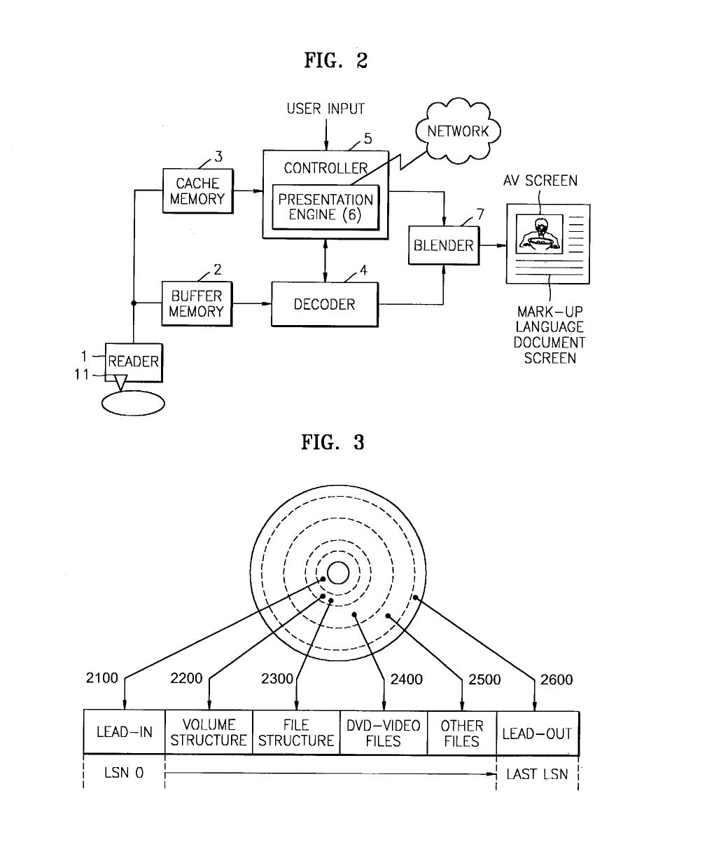

FIG. 2 is a block diagram of the apparatus 200 according to an embodiment of the present invention. Referring to FIG. 2, the apparatus 200 includes a reader 1, a buffer memory 2, a cache memory 3, a controller 5, a decoder 4, and a blender 7. The controller 5 further includes a presentation engine 6. The reader 1 includes an optical pickup 11 for reading data using a laser.

The reader 1 reads the AV data and the mark-up language documents from the DVD 300 while controlling the optical pickup 11 in response to a control signal output from the controller 5. In addition, the reader 1 also reads search information according to the present invention from the DVD 300. The search information is reference information used to access the mark-up language document and is realized by a file system of the present embodiment. The search information will be described in greater detail later.

The buffer memory 2 is provided to buffer the AV data. The cache memory 3 is provided to cache an AV data reproduction control information file used for reproducing the AV data and/or the mark-up language document recorded on the DVD 300 or other necessary information. The cache memory 3 caches the search information according to the present invention.

The controller 5 controls the reader 1, the presentation engine 6, the decoder 4, and the blender 7 so that the AV data recorded on the DVD 300 can be reproduced in either a video mode or an interactive mode. The controller 5 reads at least some of the search information used to access the mark-up language document recorded on the DVD 300 using the reader 1 and lets the read information be cached in the cache memory 3.

The presentation engine 6 in the controller 5 is an interpretation engine which interprets a mark-up language and a client interpretation program language, and performs operations according to the interpreted mark-up language. Examples of such languages include JavaScript or Java, but are not specifically limited thereto. The presentation engine 6 may further include various plugs-in. Plugs-in help the presentation engine 6 to open files of various formats included in or linked to mark-up language documents. In other words, the presentation engine 6 serves as a mark-up language document viewer (i.e., a type of Browser). In the present embodiment, the presentation engine 6 can be connected to the Internet so that it can read predetermined data from the Internet.

In an interactive mode, the presentation engine 6 brings and interprets mark-up language documents by referring to the search information (i.e., the file system cached in the cache memory 3). The presentation engine 6 identifies a position of a display window for displaying the AV data stream output from the decoder 4. The blender 7 blends the AV data stream and the interpreted mark-up language document so that the AV data stream can be displayed in the display window of the mark-up language document. As such, the AV screen can be embedded in the mark-up language document screen, and then the results of the blending to the TV 100.

FIG. 3 is a diagram illustrating the structure of the DVD 300. Referring to FIG. 3, the DVD 300 is divided into a lead-in area 2100, a volume structure area 2200, a file structure area 2300, a video file area 2400, an other files area 2500, and a lead-out area 2600. Lead-in information is recorded in the lead-in area 2100. The lead-in information includes a reference code and control data. The reference code represents information on the pit pattern of a modulation signal recorded on tracks of a disk, and the control data represent the size of a disk, the number of recordable surfaces, manufacturer information, and copyright information. Information necessary to access the AV data and the mark-up language documents recorded on the DVD 300 is recorded in the volume structure area 2200 and the file structure area 2300. In the present embodiment, a volume structure and a file structure are recorded using a universal data format (UDF) bridge file system or an ISO9660 file system. In other words, the search information according to the present invention is at least part of the UDF bridge file system or the ISO9660 file system. The AV data are recorded in the video file area 2400. The mark-up language documents are recorded in the other files area 2500. In FIG. 3, LSN represents a logical sector number.

As shown in FIG. 3, the file structure area 2300, where the file system is recorded, and the volume structure area 2200, where the mark-up language documents are recorded, are generally separated on the DVD 300. Accordingly, if the file system is used to identify locations of mark-up language documents and is not cached, the file system is recorded on the DVD 300 and must be read every time it is required to access the mark-up language document and then the mark-up language document must be accessed referring to the file system. Accordingly, in a method and an apparatus for reproducing data according to the present invention and an information storage medium according to the present invention, search information used to read the mark-up language documents (i.e., part of a file system) is cached.

A portion of the file system to be cached (i.e., a limited file system), can be determined by various methods. The limited file system may be determined depending on the capacity or a limited path name. The following description of the present invention is based upon an ISO9660 file system because the ISO9660 file system is used by conventional DVD-video standards. In addition, since the data size of the ISO9660 file system is relatively small as compared with a UDF file system, the ISO9660 file system is more appropriate for being cached. However, for example, if there is enough cache memory capacity or it is more effective to use a UDF file system for some other reason, it is possible to adopt the UDF file system instead of the ISO9660 file system. Further, it is understood that other such suitable file systems can be used or may be developed.

Method of Determining a Portion of a File System to be Cached Depending on the Capacity of the File System

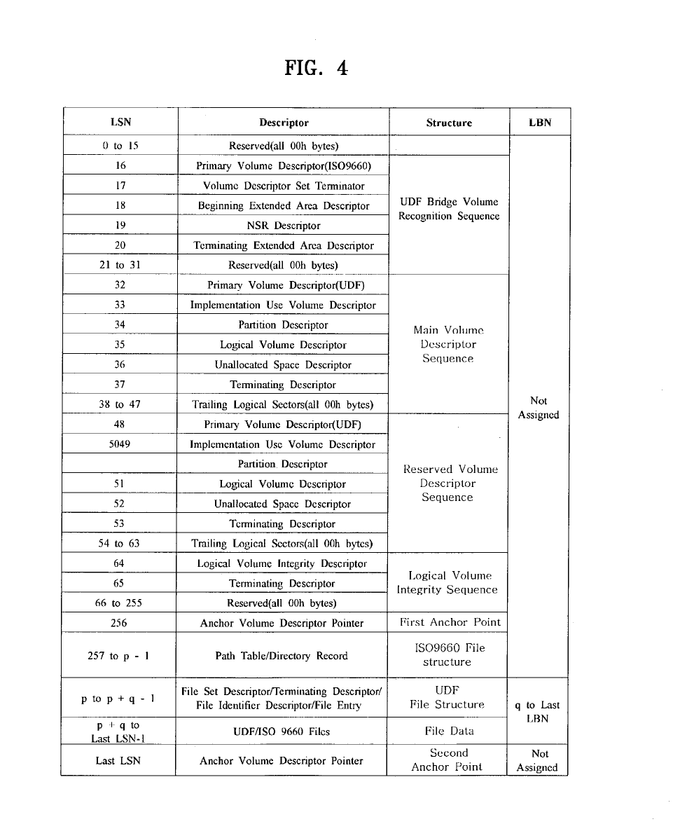

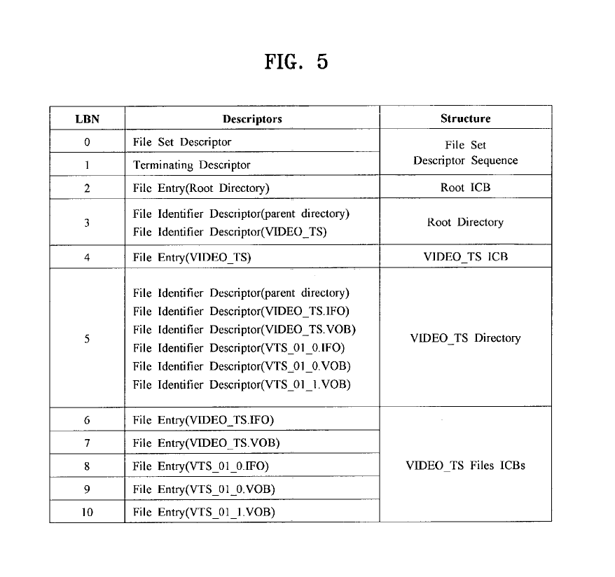

In the case of constituting the file system, as shown in FIGS. 4 and 5, an ISO9660 file system is stored in a 257-‘p-1’ logical sector range. Thus, the file system can be limited to have a size of 512 KB, which accounts for 256 sectors when one sector has a size of 2 KB, or a total amount of a path table and a directory record can be limited at 512 KB.

Supposing that each directory name has 30 letters, and there are a total of 256 directory names, the size of a path table is as follows:

Path table size=5 sectors(8+(8+30)*256)

A maximum size for a directory record in sectors is equal to 251 sectors (256 sectors−5 sectors). Here, if each file name has 30 letters and file names are separately stored in different directories, the maximum number of acceptable files amounts to about 7,000.

Method of Determining a Portion of a File System to be Cached Depending on a Directory Name

1) In an ISO9660 file system (logical sectors ranging from 257 to ‘p-1’), the size of a space corresponding to a predetermined directory path is limited.

2) A limited file system is determined by limiting the size of a predetermined directory where search information on the mark-up language documents is recorded and the size of a directory record at a predetermined level.

Hereinafter, various examples of the method of determining a limited file system by limiting the size of a directory and a directory record will be described in greater detail in the following paragraphs.

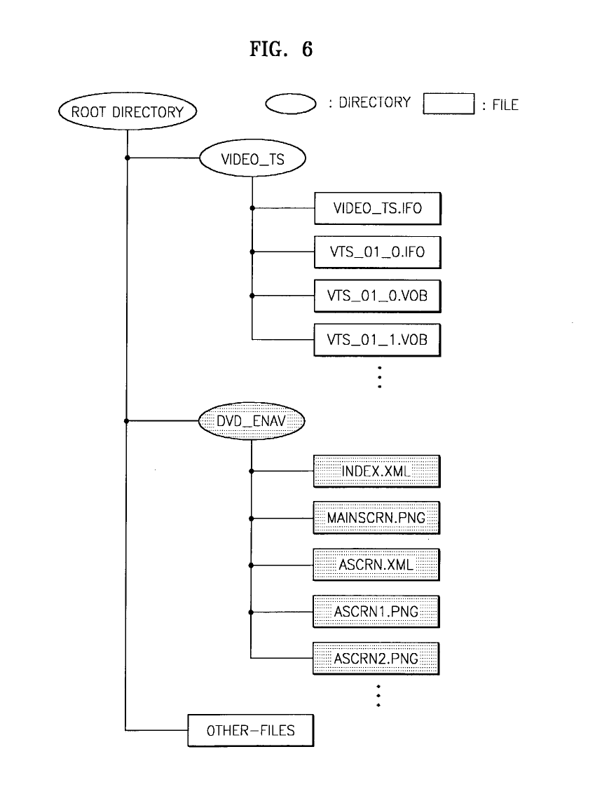

FIG. 6 is a diagram illustrating an example of the directory structure of the DVD 300. Referring to FIG. 6, a video directory VIDEO_TS, where AV data are stored, is provided in a root directory. The video directory VIDEO_TS includes a reproduction control information file VIDEO_TS.IFO, where reproduction control information on an entire video title is recorded. Further, a reproduction control information file VTS_{—}01_{—}0.IFO, where reproduction control information on a first video title is recorded, and a set of video titles VTS_{—}01_{—}0.VOB, VTS_{—}01_{—}1.VOB, . . . , constituting the AV data, are recorded in the video directory VIDEO_TS. Here, VTS_{—}01_{—}0.VOB, VTS_{—}01_{—}1.VOB, . . . , represent video titles (i.e., video objects (VOBs)). Each video object contains VOBU packaging a navigation package, a video package, and an audio package. The directory structure of the DVD 300 is disclosed in greater detail in DVD-Video standards, DVD-VIDEO FOR READ-ONLY-MEMORY DISC (1.0) (1996), the disclosure of which is incorporated by reference.

The root directory further includes an interactive directory DVD_ENAV. The mark-up language documents for supporting an interactive mode are stored in the interactive directory DVD-ENAV. In the interactive directory DVD_ENAV, INDEX.XML is recorded as a start document. In addition, other mark-up language documents are stored in the interactive directory DVD_ENAV. In other words, MAINSCRN.PNG is a file inserted into the INDEX.XML, ASCRN.XML is a file displayed with a corresponding video title, and ASCRN1.PNG and ASCRN2.PNG are files inserted into the ASCRN.XML and displayed together.

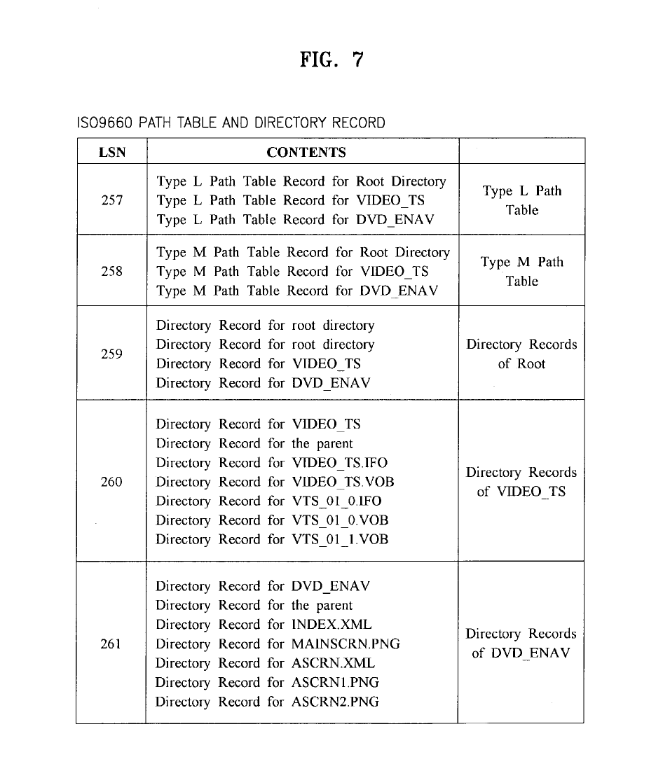

FIG. 7 is a diagram illustrating an ISO9660 file system according to the directory structure shown in FIG. 6. FIG. 7 shows a path table and a directory record structure, which are recorded according to the ISO9660 file system. Search information which can be cached in the cache memory 3 is recorded in areas (logic sectors 257 and 261) colored in grey. In the cache memory 3, search information necessary to read files recorded in the interactive directory DVD_ENAV, (i.e., part (logic sectors 257 and 261) of a file system) is cached. Accordingly, the controller 5 of the apparatus 200 can determine a location where the mark-up language documents are recorded based upon the cached search information. Therefore, there is no need to move the optical pickup 11 every time it is required to read the mark-up language documents through a process of sending a control signal to the reader 1. In other words, the controller 5 can more quickly read the mark-up language documents necessary to reproduce AV data in an interactive mode.

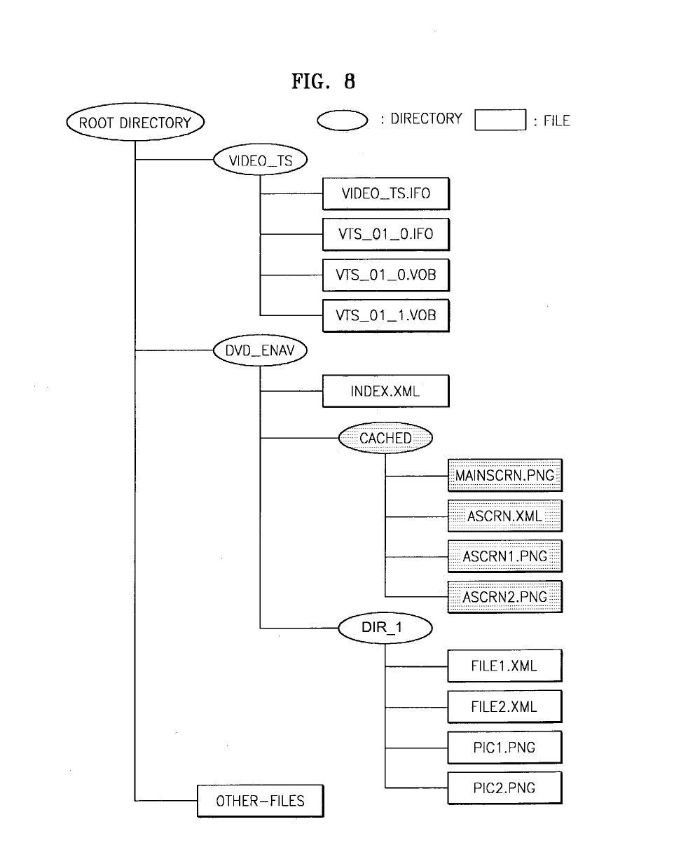

FIG. 8 is a diagram illustrating another example of the directory structure of the DVD 300. Referring to FIG. 8, the video directory VIDEO_TS, where the AV data are stored, is provided in a root directory. The video directory VIDEO_TS is the same as the one shown in FIG. 4, and thus a description thereof will not be repeated.

The root directory also includes an interactive directory DVD_ENAV, where mark-up language documents for supporting an interactive mode are stored. In the interactive directory DVD_ENAV, INDEX.XML is recorded as a start document. Cache directories CACHED and DIR_{—}1 are provided as sub-directories where other mark-up language documents are stored. MAINSCRN.PNG stored in the cache directory CACHED is a file inserted into INDEX.XML, ASCRN.XML is a file displayed with its corresponding video title, and ASCRN1.PNG and ASCRN2.PNG are files inserted into the ASCRN.XML and displayed together. FILE1.XML and FILE2.XML stored in the sub-directory DIR_{—}1 are files displayed with their corresponding video titles, and PIC1.PNG and PIC2.PNG are files inserted into FILE1.XML or FILE2.XML.

In FIG. 8, the search information necessary to access the cache directory CACHED including areas colored in grey is stored in the cache memory 3.

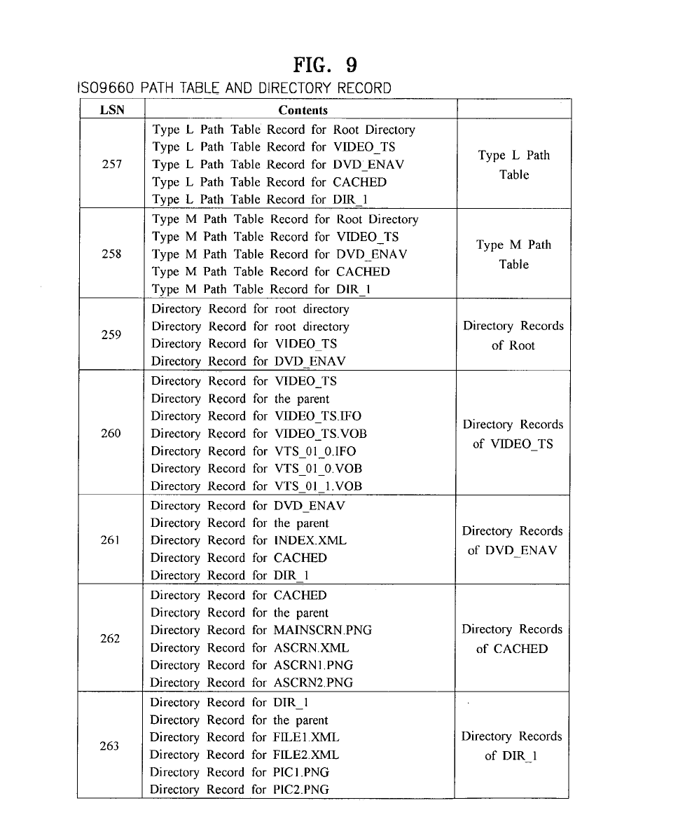

FIG. 9 is a diagram illustrating an ISO9660 file system according to the directory structure shown in FIG. 8. Specifically, FIG. 9 shows a path table and a directory record structure recorded according to the ISO9660 file system. Search information which can be cached in the cache memory 3 is recorded in areas colored in grey (logical sectors 257 and 262). In the present embodiment, the search information necessary to read files recorded in the cache directory CACHED, which is a sub-directory of DVD_ENAV (i.e., part of a file system (logical sectors 257 and 262) is cached in the cache memory 3. Accordingly, the controller 5 of the apparatus 200 can determine a location where the mark-up language documents belonging to the cache directory CACHED are recorded. Therefore, it is possible to more quickly read the mark-up language documents necessary to reproduce AV data in an interactive mode. However, unlike the search information on the mark-up language documents in the cached directory CACHED, the search information on mark-up language documents in the sub-directory DIR_{—}1 must be directly read from the DVD 300 because it is not cached.

The reason that the search information on only some mark-up language documents rather than search information on all mark-up language documents is cached (i.e., the reason that a cache directory where a file system is cached is additionally provided) is to prepare for a case where there are too many mark-up language documents recorded in an interactive directory or a case where the cache memory 3 for caching search information only has a small space. For example, as the number of mark-up language documents increases, such as when creating an encyclopaedia, the size of the search information used to access such mark-up language documents (i.e., the size of a file system) also increases. Thus, the search information or the file system accounts for too much space in the cache memory 3, or its size exceeds the capacity of the cache memory 3. In this case, it is preferable that a sub-directory is provided where mark-up language documents, which are expected to be accessed frequently, are stored and that only a file system corresponding to the frequently accessed mark-up language documents is cached.

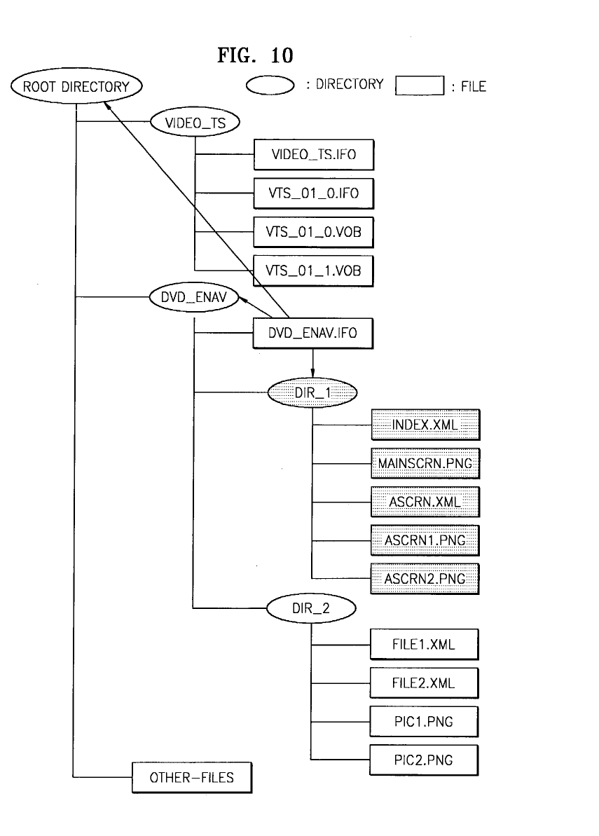

FIG. 10 is a diagram illustrating another example of the directory structure of the DVD 300. Referring to FIG. 10, a root directory includes a video directory VIDEO_TS where the AV data are stored. The video directory VIDEO_TS is the same as the one shown in FIG. 6, and thus a description thereof will not be repeated.

The root directory also includes an interactive directory DVD_ENAV where the mark-up language documents are stored so as to support an interactive mode. In the interactive directory DVD_ENAV includes sub-directories DIR_{—}1 and DIR_{—}2, where the mark-up language documents are stored. A reproduction control information file DVD_ENAV.IFO is recorded in the interactive directory DVD_ENAV. The reproduction control information file includes the definition and structure of a directory, the number of titles included in the directory, basic information on the titles, information on a language, subtitles, and fonts used in the titles, mark-up language document display information, such as resolution and colors, and copyright information. In particular, in the present embodiment, cache directory designation information according to the present invention is recorded in the reproduction control information file DVD_ENAV.IFO. The cache directory designation information indicates a directory having a data structure designated for being cached. In the present embodiment, the sub-directory DIR_{—}1 colored in grey is a cache directory. Accordingly, the search information necessary to access the sub-directory DIR_{—}1 is stored in the cache memory 3.

In the sub-directory DIR_{—}1, INDEX.XML is recorded as a start document. MAINSCRN.PNG is a file inserted into the INDEX.XML, ASCRN.XML is a file displayed with its corresponding video title, and ASCRN1.PNG and ASCRN2.PNG are files inserted into ASCRN.XML and displayed together. FILE1.XML and FILE2.XML stored in the sub-directory DIR_{—}2 are files displayed with their corresponding video titles, and PIC1.PNG and PIC2.PNG are files inserted into FILE1.XML or FILE2.XML.

Unlike in the present embodiment, an interactive directory can be designated as a cache directory as marked by DIR_{—}1 according to cache directory designation information or a root directory can be designated as a cache directory. The cache directory designation information can be recorded in the start document, for example, the INDEX.XML, where the reproduction control information is stored.

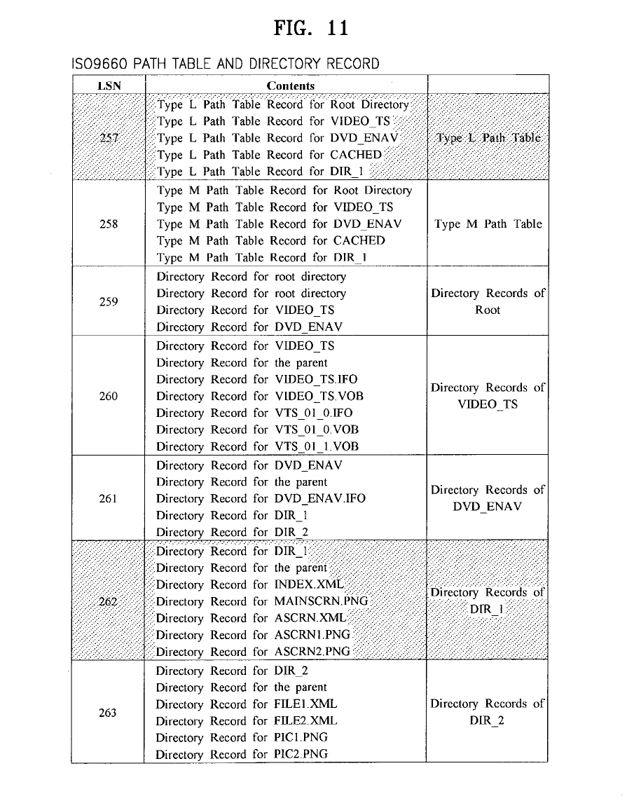

FIG. 11 is a diagram illustrating an ISO9660 file system according to the directory structure shown in FIG. 10. Specifically, FIG. 11 shows a path table and a directory record structure recorded according to the ISO9660 file system. Search information which can be cached in the cache memory 3 is recorded in grey colored areas (logical sectors 257 and 262). In the present embodiment, the search information necessary to read files recorded in the cache directory DIR_{—}1, which is a sub-directory of DVD_ENAV (i.e., part of a file system logical sectors 257 and 262) is cached in the cache memory 3. Accordingly, the controller 5 of the apparatus 200 can determine a location where the mark-up language documents belonging to the cache directory DIR_{—}1 are recorded by referring to the cached search information. Therefore, the controller 5 can more quickly read the mark-up language documents necessary to reproduce the AV data in an interactive mode. However, unlike the search information on the mark-up language documents stored in the cache directory DIR_{—}1, since search information on the mark-up language documents stored in the sub-directory DIR_{—}2 is not cached, it is necessary to read the search information on the mark-up language document stored in the sub-directory DIR_{—}2 directly from the DVD 300.

The reason that a directory structure where the cache directory DIR_{—}1 is additionally provided has been described above with reference to FIG. 7, and thus will not be repeated here.

A method of reproducing data according to the present invention will be described in the following paragraphs based upon the above-mentioned structure of the apparatus 200 for reproducing data according to the present invention. It is understood that, where the controller 5 is a computer, the method is performed using a computer readable medium encoded with software readable by the controller.

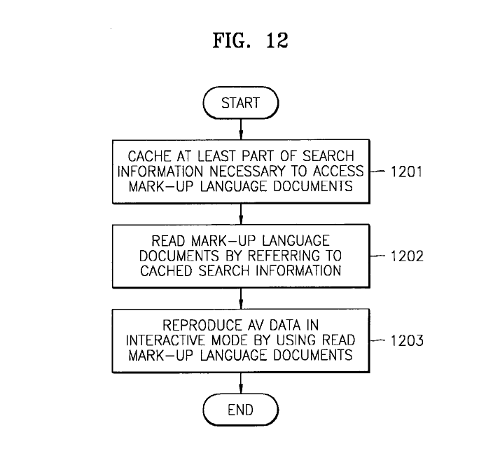

FIG. 12 is a flowchart of a method of reproducing data according to an embodiment of the present invention. As shown in FIG. 12, the apparatus 200 caches at least some search information used to access the mark-up language documents (operation 1201) when an interactive mode is selected. The corresponding mark-up language document is read from the DVD 300 (operation 1202) by referring to the cached search information. Thereafter, the AV data are reproduced in an interactive mode using the read mark-up language document (operation 1203).

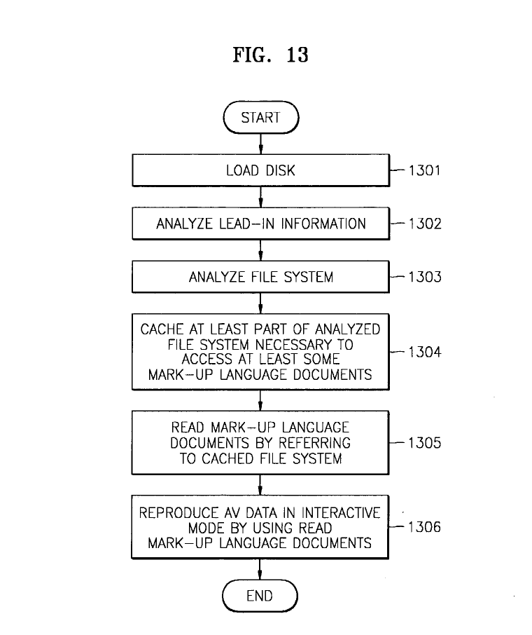

FIG. 13 is a flowchart of a method of reproducing data according to another embodiment of the present invention. Referring to FIG. 13, when a user loads the DVD 300 in a DVD drive installed in the apparatus 200 (operation 1301), the apparatus 200 obtains lead-in information, such as the type of the DVD 300, from a lead-in area recorded on the DVD 300 (operation 1302). Next, the apparatus 200 analyzes a file system (operation 1303) and caches at least some of the file system necessary to access the mark-up language documents (operation 1304). Thereafter, the apparatus 200 reads the corresponding mark-up language document by referring to the cached file system (operation 1305). Next, the apparatus 200 reproduces the AV data in an interactive mode using the read mark-up language document (operation 1306).

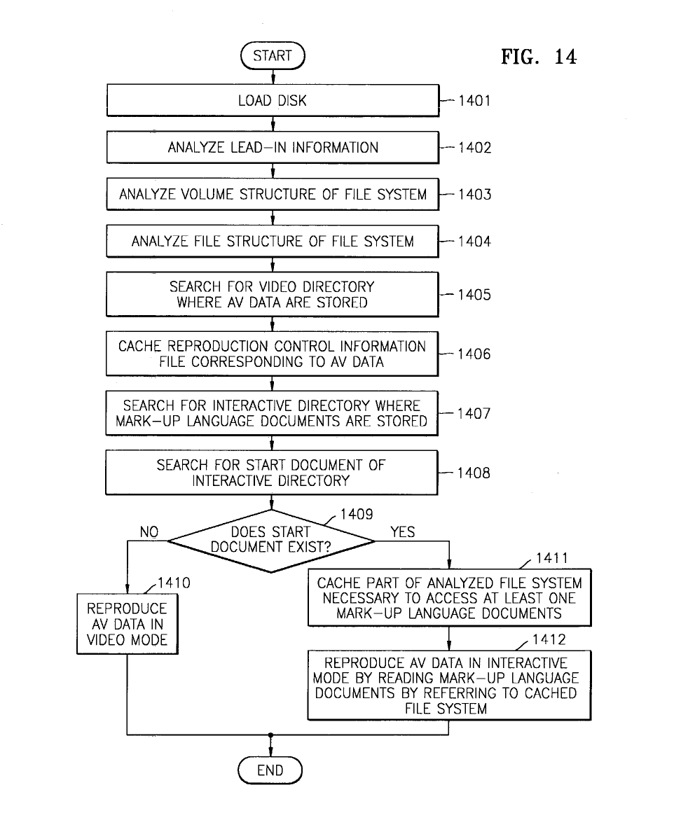

FIG. 14 is a flowchart of a method of reproducing data according to yet another embodiment of the present invention. Referring to FIG. 14, after a user loads the DVD 300 into a DVD drive installed in the apparatus 200 (operation 1401), the apparatus 200 obtains lead-in information, such as the type of the DVD 300, from a lead-in area recorded on the DVD 300 (operation 1402). Next, the apparatus 200 analyzes a volume structure of a file system (operation 1403) and analyzes a file structure of the file system (operation 1404). Next, the apparatus 200 searches for a video directory where the AV data are stored (operation 1405), and caches a reproduction control information file corresponding to the AV data (operation 1406). Next, the apparatus 200 searches for an interactive directory where the mark-up language documents are stored (operation 1407), and searches for a start document stored in the interactive director (operation 1408). If there is no start document (operation 1409), the AV data constituting the selected video titles are reproduced in a video mode (operation 1410). If there is a start document (operation 1409), the apparatus 200 caches part of the analyzed file system analyzed in operations 1403 and 1404, which is necessary to access at least one mark-up language document, (operation 1411). The corresponding mark-up language document is read by referring to the cached file system. Then, the AV data are reproduced in an interactive mode (operation 1412).

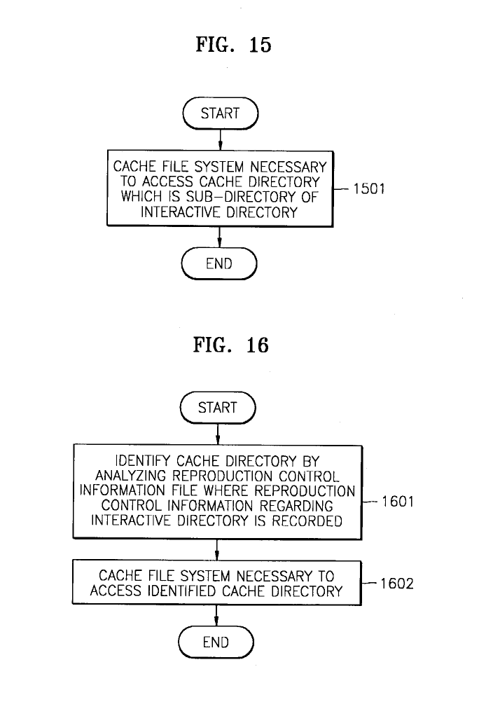

FIG. 15 is a flowchart of an example of operation 1411 of FIG. 14. Referring to FIG. 15, the apparatus 200 caches the file system necessary to access a cache directory, which is a sub-directory of an interactive directory (operation 1501).

FIG. 16 is a flowchart of another example of operation 1411 of FIG. 14. Referring to FIG. 16, a cache directory is identified (operation 1601) by analyzing a reproduction control information file where reproduction control information on an interactive directory is recorded. Then, a file system necessary to access the cache directory is cached (operation 1602).

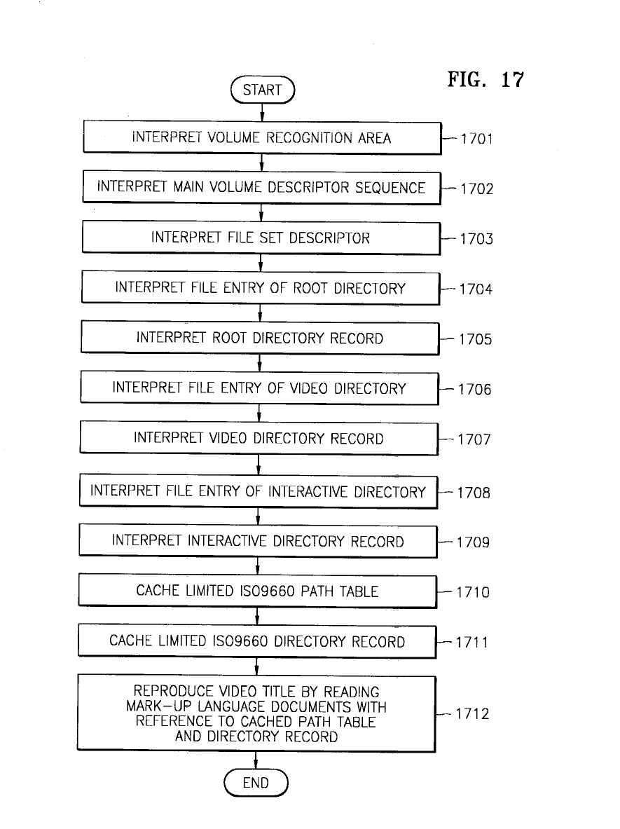

FIG. 17 is a flowchart of a method of reproducing data according to still another embodiment of the present invention in which an ISO9660 file system is used. FIG. 17 shows an operation of interpreting a file system in greater detail. Referring to FIG. 17, after a user loads the DVD 300 into a DVD drive, the apparatus 200 obtains lead-in information, such as the type of the DVD 300, from a lead-in area recorded on the DVD 300. Thereafter, the apparatus 200 reads a volume recognition area (operation 1701) by reading logic sectors ranging from logical sector 16. Specifically, the apparatus 200 determines the size and location of a path table of ISO9660 using a primary volume descriptor.

Next, a main volume descriptor sequence is interpreted (operation 1702) by referring to an anchor point. Specifically, the apparatus 200 searches for the location of the main volume descriptor sequence by referring to a first anchor point of logic sector 256. If the first anchor point is so damaged that it cannot be read, the apparatus 200 searches for the location of the main volume descriptor sequence by referring to a last logical sector, which is a second anchor point. If the main volume descriptor sequence is damaged, the apparatus 200 reads a volume descriptor sequence reserved for back-up. Thereafter, the apparatus 200 searches for a start position of a file set descriptor is searched for in a logical volume descriptor existing in the volume descriptor sequence. A start position of a partition is searched for by referring to a partition descriptor existing in the volume descriptor sequence.

Next, the file set descriptor is interpreted (operation 1703). Specifically, the location and length of a file entry of a root directory are read from the file set descriptor. Thereafter, the file entry of the root directory is interpreted (operation 1704). In other words, the apparatus 200 searches for the location of a directory record by reading the file entry of the root directory.

Next, a root directory record is interpreted (operation 1705). In other words, the apparatus 200 searches for a file entry of a video directory VIDEO_TS by reading a file identification descriptor in the root directory. Next, the file entry of the video directory VIDEO_TS is interpreted (operation 1706). Specifically, the apparatus 200 searches for a directory record area by reading the file entry of the video directory VIDEO_TS.

A video directory record is interpreted based upon the searched directory record area (operation 1707). A video manager (VMG) is cached in the cache memory 3 by interpreting the file entry of the reproduction control information file VIDEO_TS.IFO obtained as the result of the interpretation. In addition, a file entry of an interactive directory DVD_ENAV is interpreted (operation 1708). Specifically, the apparatus 200 searches for a directory record area is searched for by reading the file entry of the interactive directory DVD_ENAV.

Next, a directory record recorded in the searched directory record area is interpreted (operation 1709). In other words, the apparatus 200 searches for a file entry of a start document, for example, INDEX.XML, by reading the file identification descriptor. The apparatus 200 searches for and caches an ISO9660 path table corresponding to the mark-up language document is cached in the cache memory 3 (operation 1710) by referring to the location of the volume recognition area obtained (operation 1701). Next, an ISO9660 directory record corresponding to the mark-up language document is searched for and cached in the cache memory 3 (operation 1711). The corresponding mark-up language document is read and a selected video title is reproduced in an interactive mode (operation 1712) by referring to the cached path table and directory record.

A limited ISO9660 file system is loaded in the cache memory 3 through the above-described file system interpretation process. For example, in the case of accessing the mark-up language document INDEX.XML stored in the other files area 2500 as shown in FIG. 3, it is possible to access the mark-up language document INDEX.XML by referring to the limited ISO9660 file system loaded in the cache memory 3. Specifically, it is possible to read a mark-up language document by identifying the location of an interactive directory record with reference to a path table and the location of the mark-up language document INDEX.XML based upon the interactive directory record.

In other words, according to the present invention, the processes before the identification of the corresponding mark-up language document are performed by accessing a memory, and thus it is possible to read data by moving the optical pickup 11 to the location of INDEX.XML. Accordingly, the movement distance of the optical pickup 11 can be decreased considerably as compared with the prior art. This effect can be shown more apparently when there are many files linked to mark-up language documents.

As described above, according to the present invention, it is possible to read mark-up language documents faster by caching search information on the mark-up language document and accessing the mark-up language document by referring to the cached search information. Accordingly, it is possible to enhance the speed of reproducing data in an interactive mode and the speed of responding to a user.

Although a few embodiments of the present invention have been shown and described, it would be appreciated by those skilled in the art that changes may be made in this embodiment without departing from the principles and spirit of the invention, the scope of which is defined in the claims and their equivalents. CLAIMS

What is claimed is:

1. An information storage medium having data reproducible by a reproducing apparatus, the data comprising:
mark-up language documents for reproducing audio/video (AV) data in an interactive mode; and
search information to access the mark-up language documents,
wherein at least part of the search information is designated for being cached in a memory of the reproducing apparatus and is used by the reproducing apparatus to access at least some of the mark-up language documents.

2. The information storage medium of claim 1, further comprising the AV data, wherein the search information is information used to access the AV data.

3. The information storage medium of claim 1, wherein the search information is information used to access the mark-up language documents stored in an additional directory among the mark-up language documents.

4. The information storage medium of claim 3, wherein the search information is recorded using a file system, the volume structure and file structure of which is analyzable.

5. The information storage medium of claim 4, wherein the file system is one of a UDF file system and an ISO9660 file system.

6. An information storage medium having data reproducible by a reproducing apparatus, the data comprising:
a video directory which includes AV data including audio data and/or video data; and
an interactive directory in which are stored mark-up language documents for reproducing the AV data in an interactive mode,
wherein the interactive directory further comprises a cache sub-directory and the data structure of the cache directory is to be cached in a memory of the reproducing apparatus.

7. The information storage medium of claim 6, wherein the data structure is search information to access the mark-up language documents of the cache directory.

8. An information storage medium having data reproducible by a reproducing apparatus, the data comprising:
an interactive directory including at least one sub-directory in which mark-up language documents for reproducing audio and/or video (AV) data in an interactive mode are stored, reproduction control information on the mark-up language documents, and a reproduction control information file including cache directory designation information for designating a cache directory,
wherein a data structure of the cache directory is to be cached in a memory of the reproducing apparatus.

9. The information storage medium of claim 8, wherein the data structure is search information to access the mark-up language documents of the cache directory and is to be cached in the memory.

10. The information storage medium of claim 8, wherein the data structure is recorded using a file system, the volume structure and file structure of which can be analyzed.

11. The information storage medium of claim 10, wherein the file system uses at least one of a UDF file system and an ISO9660 file system.

12. A method of reproducing audio and/or video (AV) data stored on a recording medium in an interactive mode using a reproducing apparatus, the method comprising:
caching at least part of search information necessary to access mark-up language documents in a memory of the reproducing apparatus; and
reading the mark-up language documents from the recording medium by referring to the cached search information.

13. The method of claim 12, further comprising reproducing the AV data in an interactive mode using the read mark-up language documents.

14. The method of claim 12, wherein the caching at least part of the search information comprises:
analyzing a file system recorded on the information storage medium where the mark-up language documents are recorded; and
caching the volume structure and file structure of part of the analyzed file system necessary to access at least some of the mark-up language documents in the memory.

15. A method of reproducing audio and/or video (AV) data in an interactive mode using a reproducing apparatus, the method comprising:
analyzing lead-in information of a storage medium to determine information for replaying the storage medium;
analyzing a file system of the storage medium;
caching at least part of the file system necessary to access mark-up language documents in a memory of the reproducing apparatus;
reading the mark-up language documents of the recording medium by referring to the cached file system; and
displaying the AV data in an interactive mode using the read mark-up language documents.

16. The method of claim 15, wherein the caching the at least part of the file system comprises caching the file system used to access a cache directory in a memory and the cache directory is a sub-directory of an interactive directory which stores the mark-up language documents on the storage medium, in the memory.

17. The method of claim 16, wherein the caching the at least part of the file system further comprises determining the cache directory by analyzing a reproduction control information file where reproduction control information on the interactive directory is recorded, and caching the file system for accessing the cache directory in the memory.

18. The method of claim 15, wherein the displaying the AV data comprises:
searching for a video directory where the AV data are stored on the storage medium and caching in the memory a reproduction control information file for the AV data; and
reading the AV data by referring to the cached reproduction control information file.

19. The method of claim 15, wherein the file system adopts at least one of a UDF file system and an ISO9660 file system.

20. A method of reproducing audio and/or video (AV) data, in an interactive mode, from a digital versatile disk (DVD) on which mark-up language documents are recorded based upon an ISO9660 file system, the method comprising:
interpreting a volume area of the DVD;
interpreting a main volume descriptor sequence by referring to an anchor point determined using the interpreted volume area;
interpreting a file set descriptor using the main volume descriptor sequence;
interpreting a file entry of a root directory of the DVD using the interpreted file set descriptor;
interpreting a root directory record of the root directory using the interpreted file entry of the root directory;
interpreting a file entry of an interactive directory in which mark-up language documents are stored using the interpreted root directory record;
interpreting an interactive directory record in the interactive directory using the interpreted file entry of the interactive directory;
finding a file entry of a start document by reading a file identification descriptor using the interpreted interactive directory record;
caching a path table regarding at least some of the mark-up language documents stored on the DVD using the found start document;
caching a directory record stored on the DVD corresponding to the cached path table; and
reproducing the AV data in an interactive mode with the corresponding mark-up language documents with reference to the cached path table and the cached directory record.

21. The method of claim 20 further comprising:
interpreting a file entry of a video directory stored on the DVD;
interpreting a video directory record using the interpreted file entry of the video directory; and
caching reproduction control information by interpreting a reproduction control information file stored in the video directory using the interpreted video directory record,
wherein the reproducing the AV data comprises reading the AV data by referring to the cached reproduction control information.

22. An apparatus for reproducing data in an interactive mode from an information storage medium which stores mark-up language documents for reproducing audio and/or video (AV) data in the interactive mode, the apparatus comprising:
a reader which reads data recorded on the information includes in the data storage medium;
a cache memory which caches search information read by the reader;
a controller which commands at least part of the read search information used to access the mark-up language documents to be read and the mark-up language documents corresponding to the search information to be cached in the cache memory;
a presentation engine which interprets the read mark-up language documents;
a buffer memory which buffers AV data read by the reader;
a decoder which decodes AV data buffered by the buffer memory; and
a blender which blends the decoded AV data and the interpreted mark-up language documents and outputs a blended result.

23. The apparatus of claim 22, wherein the controller analyzes a file system recorded on the information storage medium, commands the reader to read part of a file system used to access at least some of the mark-up language documents, and controls the cache memory so that the read file system is cached in the cache memory.

24. A computer readable medium encoded with instructions for performing a method of reproducing data from a storage medium having control information, markup language documents, and video data performed by a computer, the method comprising:
caching the control information in a memory other than the storage medium; and
according to the cached control information, reading the video data and one of the markup language documents from the storage medium and reproducing the read video data and the one markup language document as a blended document for display.

25. The computer readable medium of claim 24, wherein:
the cached control information comprises location information for ones of the markup language documents.

26. The computer readable medium of claim 24, wherein:
the markup documents are stored in a first region and the video data is stored in a second region other than the first region,
the control information comprises location information regarding locations of ones of the markup language documents in the first region, and
the reading and reproducing the video data and one of the markup language documents comprises:
using the cached information to locate the one markup language document stored on the storage medium in the first region, and
reproducing the located markup language document to be combined with the corresponding video data for display.

27. The computer readable medium of claim 24, wherein:
the markup documents are stored in a first region of the storage medium and the video data is stored in a second region of the storage medium other than the first region, the control information comprises a directory including files providing locations of ones of the markup language documents in the first region, and
the reading and reproducing the video data and one of the markup language documents comprises:
using the cached directory to locate the one markup language document stored on the storage medium, and
reproducing the located markup language document to be combined with the corresponding video data for display.

28. The computer readable medium of claim 27, wherein the cached directory includes another one of the markup documents to be displayed with an item of the video data.

29. The computer readable medium of claim 28, wherein the another one of the markup documents comprises a start document.

30. The computer readable medium of claim 28, wherein the reading and reproducing the video data and one of the markup language documents comprises locating the one of the markup language documents stored on the storage medium using the cached another markup document.

31. The computer readable medium of claim 30, wherein the one markup language directory is stored in a second directory other than the directory to be cached.

32. The computer readable medium of claim 24, wherein the caching the control information comprises reproducing a file indicating a location of the control information to be cached, and caching the control information according to the reproduced file.

33. The computer readable medium of claim 32, wherein:
the reproduced file further includes information on a directory in which the markup language documents are stored.

34. The computer readable medium of claim 33, wherein the directory is one of a root directory in which the markup language documents and the video data are stored on the storage medium, and a sub-directory within the root directory in which are stored ones of the markup language documents and which does not include the video data.

35. A recording and/or reproducing apparatus for use with a storage medium including video data and markup language documents to be reproduced with the video data, comprising:
an optical pickup to read data from the storage medium;
a cache memory; and
a controller which determines whether the data includes control information to be cached in the cache memory, caches the control information in the cache memory if the data includes the control information, controls the optical pickup to read the video data and a corresponding one of the markup language documents from the storage medium according to the cached control information, and reproduces the read video data and the one markup language document to be combined as a blended document for display according to the cached control information.

36. The recording and/or reproducing apparatus of claim 35, wherein, if the controller determines that the data does not include control information, the controller reproduces the video data to be displayed without one of the markup language documents.

37. The recording and/or reproducing apparatus of claim 35, wherein the controller obtains location information for ones of the markup language documents from the cached control information.

38. The recording and/or reproducing apparatus of claim 35, wherein:
the markup documents are stored in a first region of the storage medium and the video data is stored in a second region of the storage medium other than the first region,
the control information comprises location information regarding locations of the ones of the markup language documents in the first region, and
the controller uses the cached information to locate the one markup language document stored on the storage medium, and controls the optical pickup to read the located markup language document to be reproduced and combined with the corresponding video data for display.

39. The recording and/or reproducing apparatus of claim 35, wherein:
the markup documents are stored in a first region of the storage medium and the video data is stored in a second region of the storage medium other than the first region,
the control information comprises a directory including files providing locations of the ones of the markup language documents in the first region, and
the controller caches the directory to locate the one markup language document stored on the storage medium, and controls the optical pickup to read the located markup language document to be reproduced and combined with the corresponding video data for display.

40. The recording and/or reproducing apparatus of claim 39, wherein the cached directory includes another one of the markup documents to be displayed with an item of the video data.

41. The recording and/or reproducing apparatus of claim 40, wherein the another one of the markup documents comprises a start document.

42. The recording and/or reproducing apparatus of claim 40, wherein the controller locates the one of the markup language documents stored on the storage medium using the cached another markup document.

43. The recording and/or reproducing apparatus of claim 42, wherein the one markup language directory is stored in a second directory other than the directory to be cached.
